(19) United States
(12) Patent Application Publication
(10) Pub. No.: US 2004/0218592 A1
(43) Pub. Date: Nov. 4, 2004

(54) Method and apparatus for fast contention-free, buffer management in a multi-lane communication system

(76) Inventors: Eyal Nagar, Modi'in (IL); Amir Paran, Moshav Arugot (IL); Michael Bachar, Kfar Neter (IL); Shimshon Jacobi, Rehovot (IL)

Correspondence Address: NATH & ASSOCIATES PLLC, 6th Floor, 1030 15th Street, Washington, DC, 20005, US

(21) Appl. No.: 10/600,543

(22) Filed: Jun. 23, 2003

(30) Foreign Application Priority Data
May 4, 2003 (IL) 155742

(51) Int. Cl. H04Q 11/00

(52) U.S. Cl. 370/381

(57) ABSTRACT

A data structure depicting unicast queues comprises a Structure Pointer memory for storing pointers to a location in memory of a segment of a packet associated with a respective queue. A Structure Pointer points to a record in the Structure Pointer memory associated with a successive segment, and a packet indicator indicates whether the segment is a first and/or a last segment in the packet. A Head & Tail memory stores an address in the Structure Pointer memory of the first and last packets in the queue, and a free structure memory points to a next available memory location in the Structure Pointer memory. To support multicast queues the data structure, a multiplicity memory stores the number of destinations to which a respective queue is to be routed. A scheduling method and system using such a data structure are also described.

### FIELD OF THE INVENTION

This invention relates to buffer management particularly for multicast but also for unicast queues.

### BACKGROUND OF THE INVENTION

In today's world networks systems, supporting multicast traffic is an ever-pressing need. Such systems play an important role in supporting any application that involves the distribution of information from one source to many destinations or many sources to many destinations.

Buffer management methods are an essential need in the common crossbar-based switch architecture. Data is stored at the ingress side in a virtual output queue and at the egress side in an output queue.

Dealing with ingress unicast traffic in buffer management systems is well known, since each of the incoming cells is written to a unique virtual output queue, implemented as a linked list. For multicast traffic, on the other hand, each of the incoming cells can be destined to more than one port. Thus, it requires a more complex buffer management solution.

There are several methods that address the problem of multicast traffic management. For instance, one can duplicate the cell in the shared memory, as many times as the multicast group size. Alternatively, a single cell location can be held in the shared memory, and the cell pointer duplicated to a plurality of queues.

A third solution dedicates a specific queue to multicast cells.

The main criteria for choosing a buffer management solution are:

Simple data structure, with a simple mechanism for implementing enqueue/dequeue processes.

Minimal overhead of the algorithm storage per managed queue.

Minimal access bandwidth required to and from the storage.

Avoid dependency between enqueue and dequeue processes.

Allow flexible buffer size for unicast and multicast.

One such approach is disclosed in U.S. Pat. No. 5,689,505 (Chiussi) entitled “Buffering of multicast cells in switching networks” published Nov. 18, 1997. It discloses an ATM egress buffer management technique for multicast buffering. A copy of the data payload pointer is replicated to the corresponding linked list queues according to a multicast bitmap vector. This reference does not, however, cater for variable packet size. Moreover, it provides a solution for the egress side of the switch only, and not for the ingress side, which usually involves more queues and therefore requires more effective per-queue storage management.

Another such an approach is disclosed in U.S. Pat. No. 6,363,075 (Huang et al.) that issued on Mar. 26, 2002. It discloses a packet buffer management using a bus architecture and whose data structure has several overheads, for example requiring the used multicast pointers to be kept in a link list, and requiring a scanning mechanism for releasing them. No flexibly is given, however, in the division of the shared memory between the different types of traffic.

### SUMMARY OF THE INVENTION

It is a principal object of the invention to provide a method and system for managing multicast and/or unicast queues so as to allow independent management of enqueue and dequeue processes.

It is a particular object of the invention to provide a deterministic contention resolution between enqueue and dequeue processes of unicast or multicast queues.

A further object of the invention is to introduce an ingress packet buffering method for all kind of traffic (broadcast, multicast and unicast).

Yet another object of the invention is to provide a method for using a common memory for both multicast and unicast cells so as to enable flexibility in the memory division between the traffic types, at any given moment.

A still further object is to provide a capability to handle data having variable packet sizes, which enables integration with non-fixed cell size systems.

Another object of the invention is to enable concurrent processing of several dequeue processes.

These objects are realized in accordance with the invention by a multiple-queue management scheme, which supports unicast, multicast and broadcast traffic while keeping efficient payload and pointer memory use, regarding both memory size and memory access bandwidth. The invention provides a method for managing enqueue and dequeue processes which may occur concurrently, using data structures for free pointer-to-data FIFO, multiplicity table, queue head and queue tail pointer table, linked list tracking table, and a special queue snapshot.

Multiple linked lists are managed concurrently, one for each queue. An enqueue process, in which data is appended to a specific queue, is performed by either opening a new link list if none exists or by adding a payload pointer at the tail of the linked list, which is associated with the specific queue. A dequeue process to a specific queue starts by registering the head and the tail of the linked list which is associated with the specific queue. This registered head and tail form a virtual linked list that is called the “snapshot” linked list. The process continues with stripping one or more payload pointers as required from the snapshot linked list. While a dequeue process takes place in a certain queue, all concurrent enqueue processes to the same queue are executed on the assumption that the queue is empty, thus creating a new linked list of newly arriving payload pointer. After the dequeue process has stripped the required number of payload pointers from this queue, concatenation is performed between the snapshot linked list and the new linked list.

According to a broad aspect of the invention there is provided a data structure depicting one or more queues storing data to be routed by a unicast scheduler, said data structure comprising:

a Structure Pointer memory comprising multiple addressable records, each record storing a pointer to a location in memory of a packet associated with a respective queue, a Structure Pointer pointing to a record in the Structure Pointer memory associated with a successive packet in the queue, a packet indicator indicating whether the segment is a first segment and/or a last segment in the packet,

a Head & Tail memory comprising multiple addressable records, each record storing for a respective queue a corresponding address in the Structure Pointer memory of the first and last packets in the queue, and

a free structure memory comprising multiple addressable records, each record pointing to a next available memory location in the Structure Pointer memory.

Such a data structure is suitable for use with unicast queues but may be adapted for use also with multicast queues by the further provision of a multiplicity memory comprising multiple addressable records, each record storing a value corresponding to a number of destinations to which a respective packet is to be routed.

According to another aspect of the invention there is provided a method for receiving and dispatching data packet segments associated with one or more unicast queues, the method comprising:

(a) storing received packets, segment by segment, each associated with said queues in a data structure that is adapted to manage data packets as linked lists of segments, in the following manner:

i) for each arriving segment, fetching a structure pointer from a free structure reservoir, and fetching a data segment pointer from a free data pointer reservoir;

ii) storing the data segment in a memory address pointed to by said data segment pointer;

iii) storing the data segment pointer in the structure pointed to by the structure pointer;

iv) maintaining a packet indicator in the data structure for indicating if the current segment is a first segment or a last segment or an intermediate segment in the packet;

v) appending the data structure to a structure linked list associated with said queue;

(b) dispatching stored packet train comprising a specified number of segments, segment by segment, from a specified queue using the following steps:

i) creating a snapshot of the linked list associated with said specified queue by copying the list head and tail structure pointers to a snapshot head and snapshot tail pointers;

ii) fetching a data segment pointer from the structure pointed to by the snapshot head pointer,

iii) dispatching a current data segment pointed to by said data segment pointer;

iv) updating the snapshot head pointer to point to a successive structure in the linked list;

v) repeating (ii) to (iv) until the packet indicator of the current segment indicates that the current segment is the end of packet, and dispatching all segments of a successive packet in the queue would result in dispatching more data segments than said specified number of segments;

vi) concurrent with stages ii) to v), allowing reception of segments of newly arrived packets to continue, according to the following measures:

(1) upon arrival of a first segment, initializing the linked list of the specified queue;

(2) storing and managing segments according to stages (a) i) to v);

vii) upon completion of stage (b) v), concatenating segments as follows:

(1) if no new segments have arrived, copying the snapshot head and tail pointers to the queue linked list head and tail pointers;

(2) if the snapshot linked list were completely emptied, preserving the queue linked list, and holding only the newly arriving segments;

(3) otherwise, concatenating the linked list of the newly arrived segments to the snapshot linked list.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally a data switch utilizing the invention for managing its input and output queues.

FIG. 2 is a block diagram of a Buffer Management Unit for use in the data switch shown in FIG. 1.

FIG. 3 is a schematic representation of a data buffer having shared memory allocation.

FIG. 4 is a schematic representation showing a pair of queues whose data is maintained in a data buffer and managed via a two-level linked list.

FIG. 5 is a representation of a data structure relating to the queues shown in FIG. 2 and which is manipulated by an algorithm according to the invention.

FIGS. 6a and 6b show schematically successive stages of the algorithm according to the invention for implementing an enqueue processs having no simultaneous dequeue process to queue #2.

FIGS. 7a to 7e show schematically successive stages of a departure dequeue process from queue #1.

FIGS. 8 to 10b show schematically an optional mechanism that overcomes the contention between the enqueue and dequeue processes.

FIG. 11 shows schematically the operation of a buffer management unit with multiple grant slots.

### DETAILED DESCRIPTION OF THE INVENTION

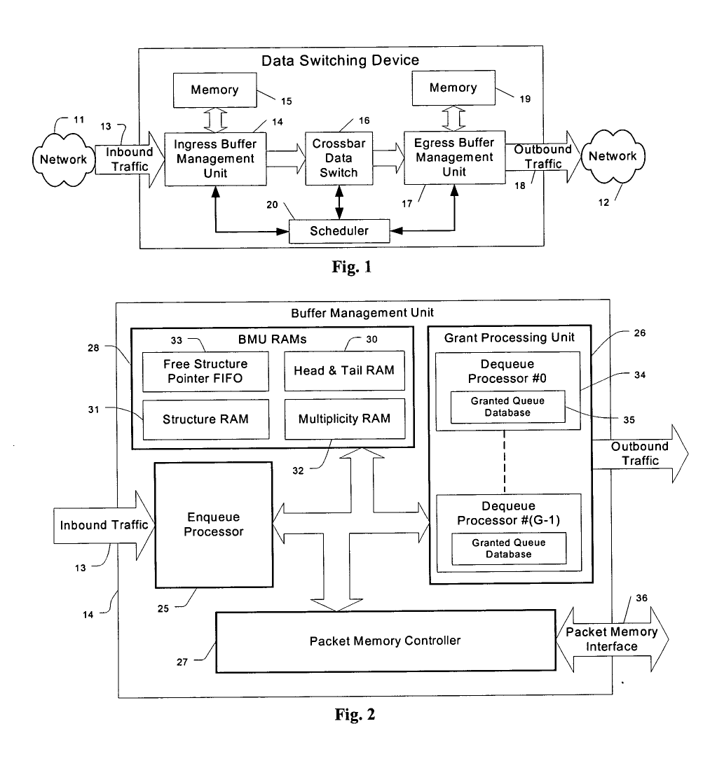

FIG. 1 shows functionally a data switch depicted generally as 10 that routes data between two nodes of a network 11 and 12. The node 11 represents an input node that routes inbound traffic 13 to an ingress Buffer Management Unit 14, which is connected to an input queues memory 15 that serves to buffer the inbound traffic 13 prior to processing by the Ingress Buffer Management Unit 14. A Crossbar Data Switch 16 is connected to an output of the Ingress Buffer Management Unit 14 and to an input of an Egress Buffer Management Unit 17 that routes outbound traffic 18 to an output node represented by the node 12. An output queues memory 19 connected to the Egress Buffer Management Unit 17 serves to buffer the outbound traffic 18 prior to processing by the Egress Buffer Management Unit 17. A scheduler 20 is coupled to the Ingress Buffer Management Unit 14, to the Egress Buffer Management Unit 17 and to the Crossbar Data Switch 16.

FIG. 2 shows schematically the Buffer Management Units 14 and 17. Inbound traffic 13 is fed to an Enqueue Processor 25 connected via a common data bus to a Grant Processing Unit 26, a Packet Memory Controller 27 and a memory block shown generally as 28. The memory block 28 includes a Head & Tail RAM 30, a Structure Pointer RAM 31, a Multiplicity RAM 32 and a Free Structure Pointer FIFO 33. The Grant Processing Unit 26 includes for each queue a dequeue processor 34 having a Granted Queue Database 35. The Grant Processing Unit 26 routes outbound traffic to the Crossbar Data Switch 16 or the output node 12 as appropriate. The Packet Memory Controller 27 is coupled to a Packet Memory Interface 36 and takes the inbound traffic's payload and puts it in the main data memory (corresponding to the memories 15 or 19 in FIG. 1, depending on the BMU position in the data switch system). The main data memory resides outside the Buffer Management Unit and retrieves the payload from the main buffer memory when time comes to send it outbound.

The Ingress Buffer Management Unit (BMU) 14 places the inbound traffic entering the data switch 10 in the input queues memory 15 until granted by the scheduler 20. Then, it is placed in the output queues memory 19 by the Egress BMU 17. Each of the BMUs manages buffer memory by performing two atomic operations, namely ‘enqueue’ and ‘dequeue’.

Further describing the BMU operation, when an ingress unicast or a multicast packet arrives, it is divided to fixed segments of payload. If a reminder is left it is padded to a segment size. This segmentation enables a wide support for any packet size. Each segment is located at a specific address in the shard memory, which is determined according to a free data pointer FIFO. The free data pointer list contains all the available addresses that are not used currently. The address in which the segment of that is located is called data pointer (DPTR).

The Buffer Management Unit (BMU) receives descriptors. Each descriptor holds the above DPTR together with additional information about the original packet. The additional information indicates the type of traffic (multicast, unicast or broadcast), the segment position in the original data packet (start, end or middle of the packet), the destination of this packet, and the quality of service (QoS) of this packet. All of the above information is considered by the Enqueue procedure and the Dequeue procedure. The destination and the QoS map the targeted queue. The queue elements are called structures. Each queue is a link list of structures. The first structure of the list is the queue head and the last queue of the list is the queue tail. The Enqueue commences from the tail and the Dequeue commences from the head. Each structure holds the DPTR. Each structure holds a structure pointer (SPTR) to the next structure in the queue. Each structure holds a packet indicator, which signal the location of the segment pointed by the structure in the original packet (start, end or middle of the original packet).

The Enqueue of a unicast descriptor requires one structure. The Enqueues of multicast or broadcast descriptors require as many structures as the multiplicity group. Each multicast descriptor has multicast address, which is used to determine which destination ports should be targeted. For example, the multicast address can be used as an address into a look up table, where each line in the look up table is a bit mask. The bit mask width is the number of destinations in the system. Each bit in the bit mask is associated with a unique destination in the system. According to the bit mask, the enqueue procedure adds structures to the relevant queues. Each structure added has the same DPTR.

The Dequeue and Enqueue mechanisms both access and modify the same descriptor and structure database. Hence, the mechanisms may work simultaneously as long as they work on different queues or, in the case where they work on the same queue, as long as the queue they both work on holds more than one structure. The above reveals a possible problem of contention between the enqueue and dequeue processes. There are three different situations of simultaneous access to the data storage, both from the enqueue and the dequeue processes:

(i) When only a single structure exists in the queue, simultaneous access to head tail RAM (Random Access Memory) might occur:

The enqueue process reads the queue tail, while the dequeue process writes the value NULL to the queue tail.

(ii) When only a single structure exists in the queue, the queue head address is equal to the queue tail address. Thus simultaneous access to the structure RAM might occur:

The dequeue process tries to read queue head entry, while the enqueue process updates the next structure pointer field.

(iii) When the queue is empty, simultaneous access to the head tail RAM might occur:

The dequeue process reads the queue head, while the enqueue process writes the queue head simultaneously.

In all three examples the system must ensure that both actions will not happen simultaneously. A solution using prioritization is acceptable but may decrease the performance of the buffer management unit significantly, since the probability of contention between enqueueing and dequeueing processes increases as traffic throughput increases.

In order to maximize efficiency, the method according to the invention avoids dependency between the enqueue and the dequeue processes. Thus, performance is not dependent on the traffic arrival process, the scheduler service algorithm, or on any interdependence between them.

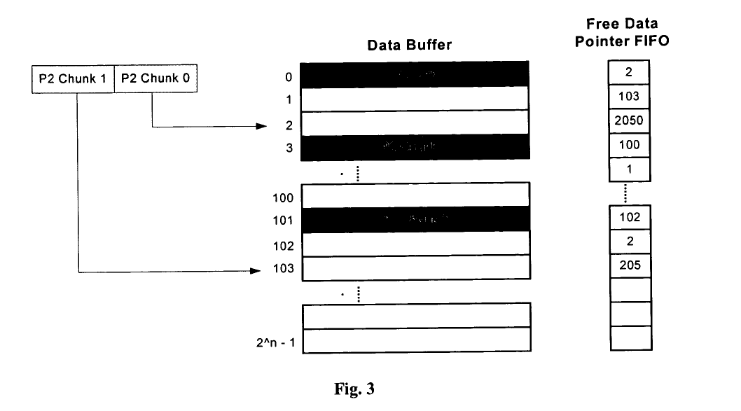

FIG. 3 shows schematically the memory partition. Each of the incoming segments is placed at the first available place in the memory. For example, assume a packet composed of two segments arrives. It can be seen that segment 0 of the packet will be written to data pointer 2, and segment 1 of the packet will be written to data pointer 103.

It should be stressed that both unicast and multicast packets can be located at any free space in the buffer. Moreover the invention enables control of the amount of memory allocated to each of the traffics flows. Memory limits are determined using two counters for multicast and unicast packet arrivals. These counters are compared to a configurable threshold value. This value defines the maximal space for each of the traffics flow in the memory.

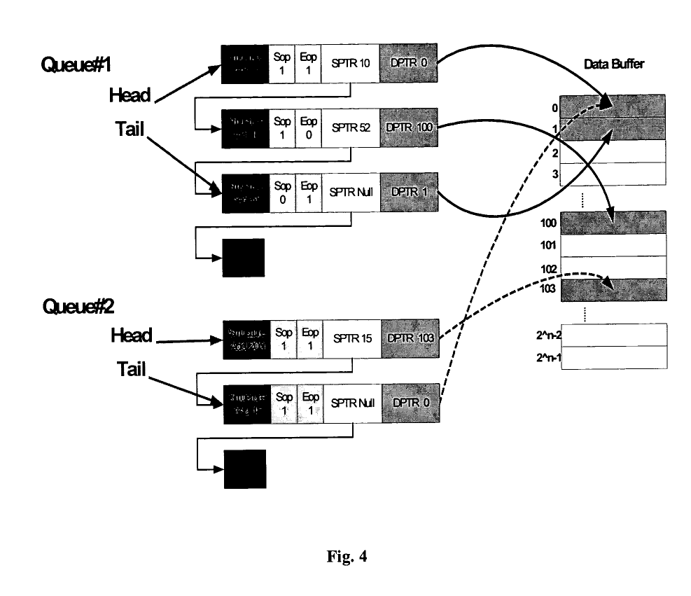

FIG. 4 shows a schematic list of two queues #1 and queue #2. Each structure in the queue has two pointer fields. One points to the next structure in the linked list of the queue and the other points to the segment of data in the shared memory. The End-of-Packet (Eop) bit signals the end of the original packet. The Start-of-Packet (Sop) bit signals the beginning of the original packet. If both are enabled then this structure is both the beginning and the end of the packet. If both are disabled, then the structure is somewhere in the middle of the packet.

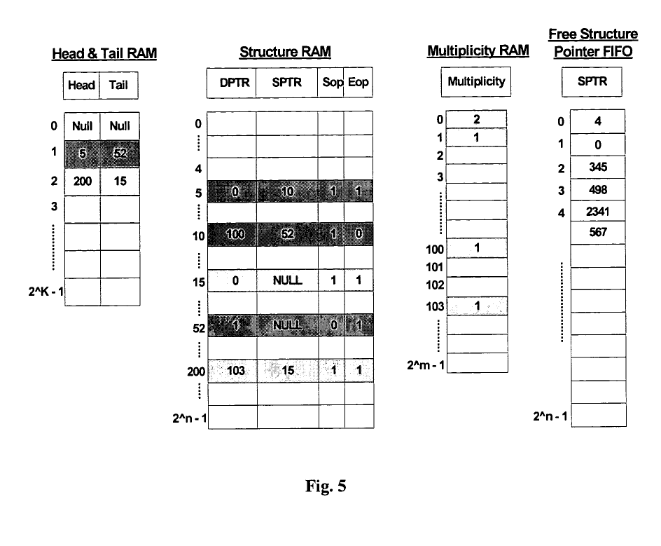

FIG. 5 shows the data structures needed to implement the linked list queues shown schematically in FIG. 4 and depicted functionally in FIG. 2 by the memory block 28. The head & tail RAM 30 holds the head and tail structures pointer of each queue. The structure RAM 31 holds a linked list of structures for each queue. The multiplicity RAM 32 has the same address span as the shared memory. Each address holds the number of structures that point to this location in the shared memory. Finally, the free structure FIFO 33 holds pointers to all structure pointers that are not currently in use.

It is clear from FIG. 5 that the head structure of queue #1 is structure #5, and its tail is structure #52, as can be seen at address 1 of the head & tail RAM.

The link list of queue #1 is composed of structures #5, 10 and 52, as can be seen from the structure pointer RAM. Structures #10 and #52 constitute a single packet composed of two segments, according to the Sop/Eop signals.

Address 0 of the multiplicity RAM contains the value 2, which is the number of structures pointing to data pointer #0. It is seen from the structure pointer RAM that the data pointers of both structures #5 of queue #1 and #15 of queue #2 point to this data location.

The first free structure to be used is structure #4, since this is the first structure at the head of the free structure FIFO.

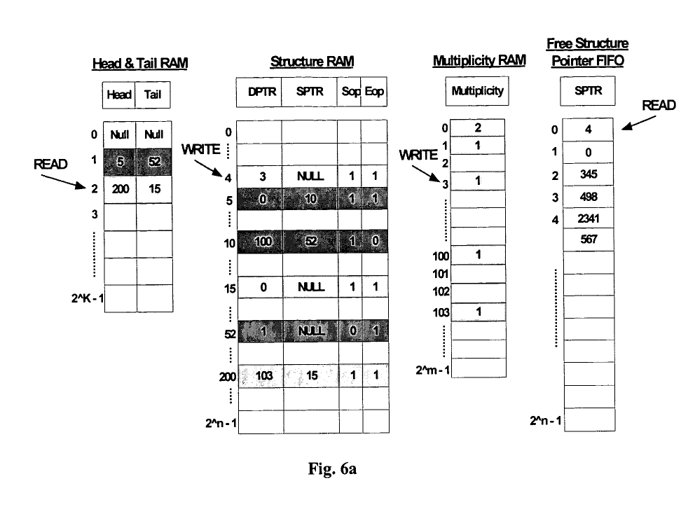

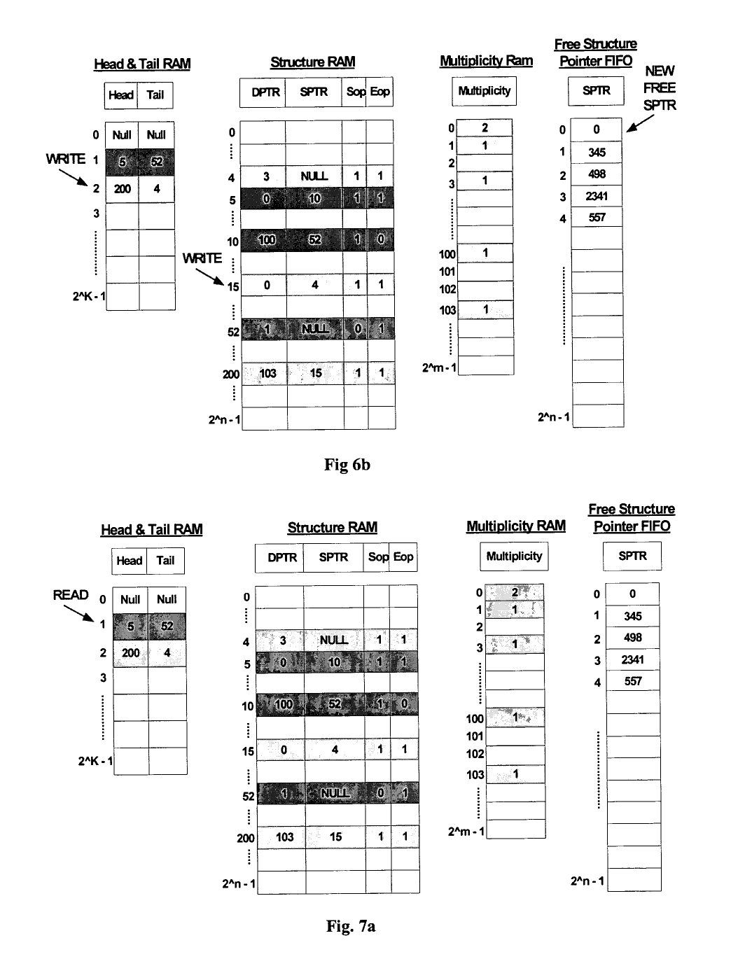

Referring to FIG. 6a, there is shown an example where there arrives at queue #2 a segment of a packet that was previously stored in the shared memory at address #3 as pointed to by the data pointer in the structure pointer RAM.

In the first stage of the enqueue process memory locations of the data structure RAM are accessed. Address #2 of the head & tail RAM is read in order to learn queue #2's old tail structure pointer, and in parallel a new tail structure is written to the structure RAM at the next available structure #4 indicated by the free structure pointer FIFO. The free structure pointer FIFO is read to advance to the next available structure pointer. The multiplicity RAM is updated at address #3, corresponding to the address of the data pointer that points to the location in the shared memory to which the new data has arrived.

Head & Tail RAM Updates:

There is no change to the head & tail RAM but only a read transaction from address #2.

Multiplicity RAM Updates:

The multiplicity RAM value at address #3 is changed to 1 since the enqueue is unicast and there is therefore only one structure pointing to it.

Structure RAM Updates:

The new structure is stored at address #4 since, as noted above, this is the next available structure indicated by the free structure pointer FIFO. Its structure pointer field is set to point to Null because this structure is the new tail of queue #2.

Free Structure Pointer FIFO Updates:

Since the data structure pointed to by the head pointer (4) of the free structure FIFO is now in use, this pointer is popped from the FIFO so that the next free structure (345) is now be pointed to by the next available free structure pointer.

Referring now to FIG. 6b, it is seen that at the second step of the enqueue process, the next SPTR of the old tail at address #15 is changed to point to the new tail structure at address #4. This action connects the new structure to the list. The tail field of the head & tail RAM is likewise updated.

Head & Tail RAM Updates:

The tail field at address #2 of the head & tail RAM is updated to the value 4 (the address of the new tail structure).

Multiplicity RAM Updates:

No change.

Structure RAM Updates:

The structure pointer field of the old tail structure (structure #15) is updated to point to the new tail (structure #4).

Free Structure Pointer FIFO Updates:

Structure #4 is removed from the free list and the next available structure is #0.

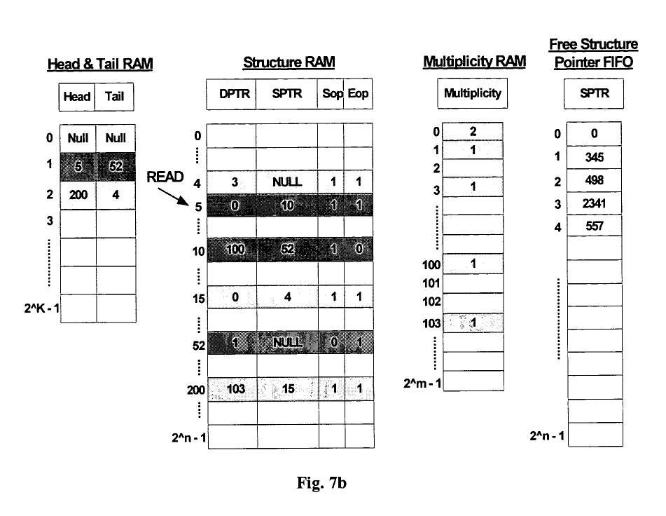

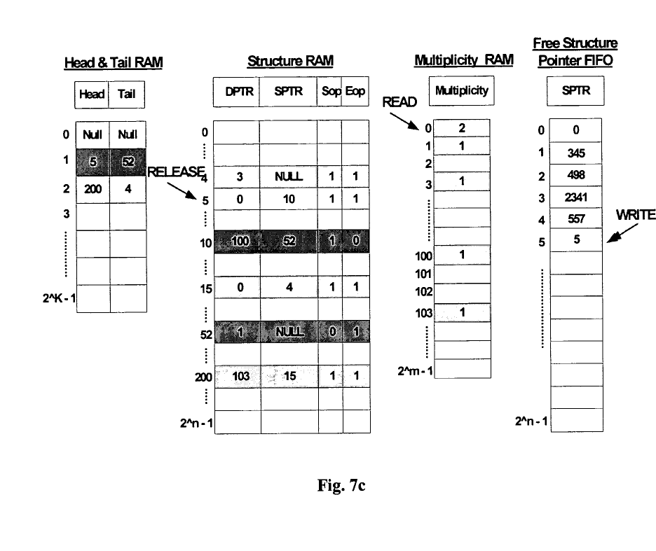

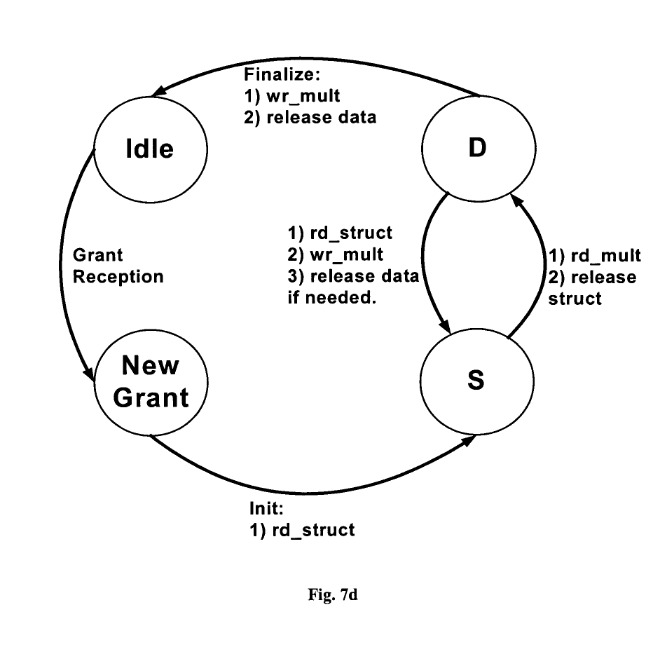

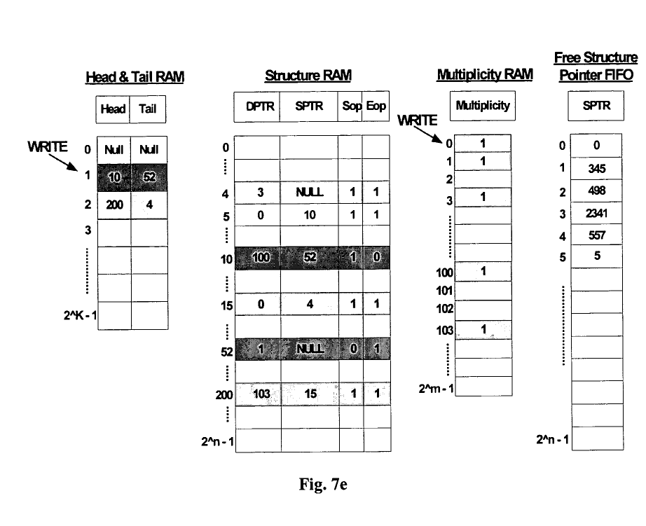

FIGS. 7a to 7e demonstrate a dequeue process from queue #1.

The Grant Processing Unit 26 within the BMU receives requests for departing data, the data departing from a given queue of the data structure as described above with reference to FIGS. 2, 5, 6a and 6b of the drawings. The Grant Processing Unit 26 processes the requests in order to determine which to grant based on predetermined criteria. The Grant Processing unit includes a plurality Grant Processors, each adapted to handle a single grant at a time by a corresponding dequeue process, thus allowing the Grant Processing to process an equal plurality of grants to the number of Grant Processors concurrently.

Thus, the dequeue process is always preceded with the scheduler sending a “grant” message to the Buffer Management Unit (see FIG. 1). The grant message informs the buffer management unit as to which queue needs to release data, and also includes the number of data structures (which relate to the amount of data) to be released. The operation of the scheduler is not itself a feature of the present invention.

Therefore, in each dequeue process a burst of structures is released. For each structure released a data segment is transmitted. The following example is of a grant of one structure.

When the Buffer Management Unit receives the grants, it prepares the queue data for transmission. This system enables the bandwidth to be reduced for access to the head & tail RAM allowing use of single port instead of a dual port.

The dequeue process performs only two accesses to the head & tail RAM, one at the beginning of the grant, and the other at the end of it, all the rest of the bandwidth being freed for the enqueue process.

FIG. 7a depicts the first operation of the dequeue process where the head & tail RAM is read at the address of the queue granted (queue #1). This is done in order to learn the queue head structure pointer, showing that structure #5 is the head, and structure #52 is the tail.

FIG. 7b depicts the next operation, during which the head structure of the queue (structure #5) is read from the structure RAM. This is done in order to learn the DPTR field of the structure (DPTR #0) and the next SPTR at the queue (structure #10).

FIG. 7c depicts the next operation, during which the structure is released; the appropriate location of the multiplicity RAM is read corresponding to the DPTR field (DPTR #0) of the structure that has been released. The multiplicity value of DPTR #0 is equal to 2, because another structure in the system (structure #15 of queue #2) has a DPTR equal #0 (this is a consequence of multicast). After releasing the structure (structure #5), its pointer value is added to the free structure pointer FIFO.

FIG. 7d depicts a state machine of the dequeue process. Upon reception of a grant, the state of the BMU is changed from “Idle” to “New Grant”. Concurrently, the BMU fetches the granted queue's Head and Tail as described above with reference to FIG. 5a of the drawings. Passing from “New Grant” state to “S” state is done unconditionally, with the first structure that is read. In “S” state, the structure fields are valid and can be sampled. When passing from “S” state to “D” state the structure is released and the read transaction from the multiplicity RAM is initiated, according to the structure DPTR field. In state “D” it is decided whether to release the DPTR of structure as well (multiplicity=1), or whether to decrement the multiplicity by one and not to release the DPTR of the structure (multiplicity>1). In state “D” there are two options: either to pass to state “S”, or to pass to the state “Idle”. The first option is done in the steady state of the grant process, a read of a new structure is initiated; the multiplicity RAM is updated with multiplicity−1. The second option is done at the end of a grant process when the last structure of the grant has already been read and all that remains is to decide whether to release the DPTR and to update the multiplicity RAM.

FIG. 7e shows a final operation where the head & tail RAM is updated with the new head and tail of the queue after entering state “New Grant” at the end of a grant. Since the value of the multiplicity RAM at address #0 exceeds 1, it is decremented. The original value was 2, meaning that two structures point to this location in the shared memory (owing to multicast). After one is released, only one structure points to this location in the shared memory. The head of queue #1 is updated to structure #10, being the next SPTR field of the last released structure.

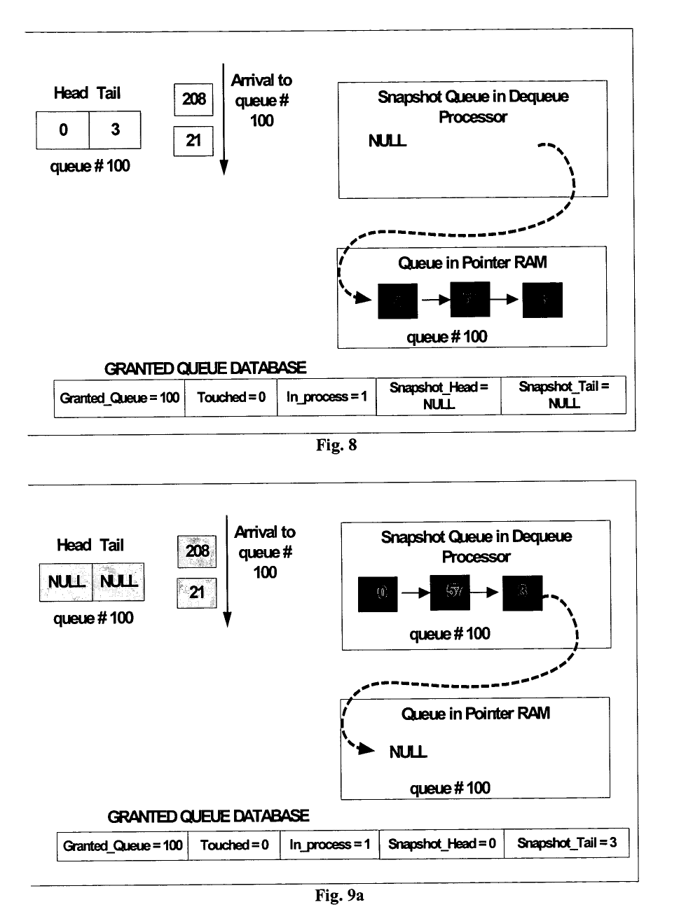

FIGS. 8 to 10b show a mechanism that overcomes the contention between the enqueue and dequeue processes explained previously.

In FIG. 8 the dequeue process is outlined by example. In this example, queue #100 is granted.

The dequeue process maintains a “Granted Queue Database”, which includes the following fields:

Granted_Queue, which holds the index of the granted queue (100 in the example).

Snapshot linked list's pointers, Snapshot_Head and Snapshot_Tail are initialized to hold a snapshot of the granted queue.

In_process flag is set to ‘1’ at the beginning of a grant and reset to ‘0’ at the end of it and indicates that the granted queue is now accessed by a dequeue process. In the example shown in FIG. 8, it equals 1 indicating that queue #100 is in a dequeue process.

Touched flag indicates that one or more structures have been added to the queue. To this end, it is reset at the beginning of a dequeue process, and the first enqueue to the granted queue, while the queue's In_process flag is set, will set the queue's Touched flag.

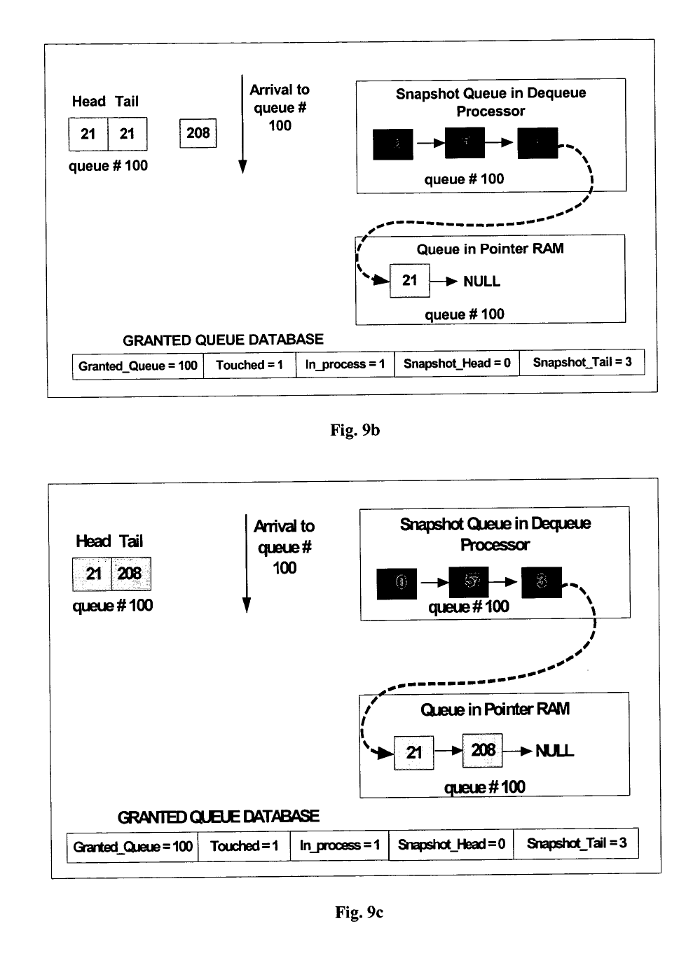

As shown in FIG. 9a, the head and tail of queue #100 still reflect the snapshot given to the dequeue process (#0 head and #3 tail). The queue's In_process flag=1. Two new structures #21 and #208 are about to enter queue #100.

FIG. 9b shows that the first structure (#21) has entered the queue #100. The structure matches the Granted Queue and the In_process flag=1 and the Touched flag=0. From the beginning of the dequeue process the queue is considered as an empty dummy, therefore the incoming structure is the only structure in the new queue, and its index is written to the head and tail of the queue in the head & tail RAM. The Touched flag is set, and next SPTR field of the old tail (structure #3) is diverted to the new structure (structure #21) to reflect the fact that they belong to the same queue.

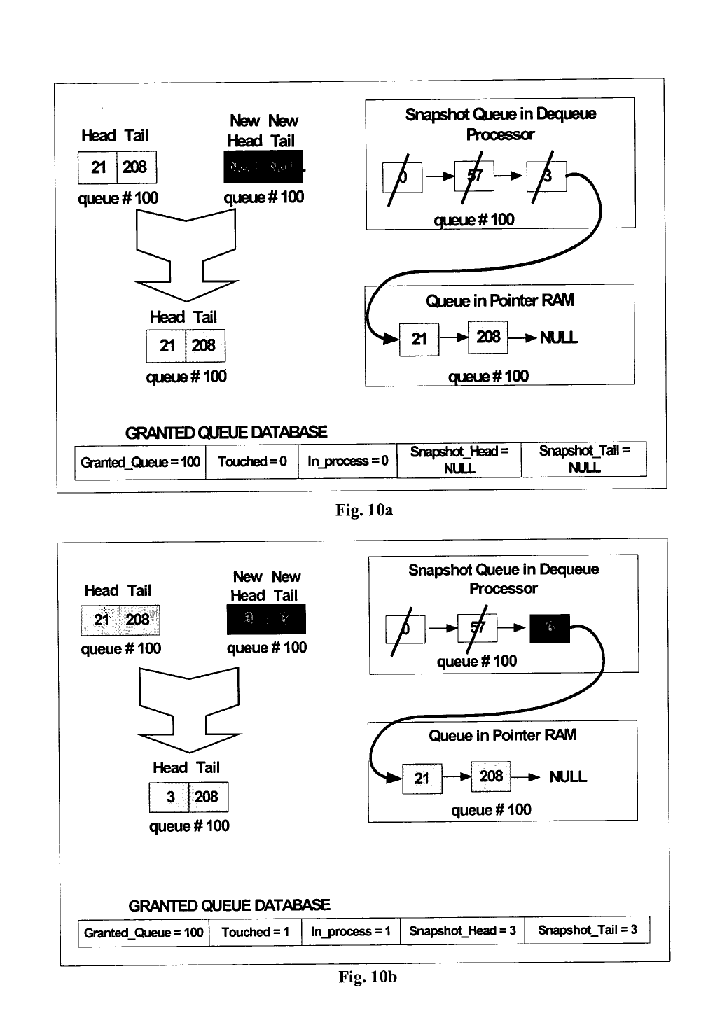

FIG. 9c shows the subsequent stage where the second structure (#208) has entered the queue #100. Since the Touched flag is already set, it is considered as a regular enqueue process and behaves as described above with reference to FIGS. 4a and 4b. Thus, the tail of queue #100 is updated with the new structure (#208). FIGS. 10a and 10b depict a concatenation process between the snapshot and the original queues, which is needed when the dequeue process ends.

The Grant Processor updates the queue head and tail according to the following rules:

First two temporary values are defined, temp_Head and temp_Tail, and set as follows;

1. First, the temporary values temp_Head and temp_Tail are initialized to the values of the granted queue head and tail values taken from the head & tail RAM, respectively;

2. If the queue was cleared, both temp_Head and temp_Tail are set to NULL.

3. If the queue was not cleared, the temp_Tail preserves its value, and the temp_Head is set to point to the last structure, which was not released.

Then, concatenation proceeds as follows:

4. If the queue was not touched by the enqueue process, both head and tail values of the head & tail RAM are set to the values of temp_Head and temp_Tail, respectively.

5. If the queue was touched by the enqueue process, and the Grant Processor did not release its tail (i.e. the snapshot queue has not yet been cleared), only the queue head will be updated to the value of temp_Head, while the queue tail preserves its value.

6. If the queue was touched by the enqueue process, and the Grant Processor released its tail (i.e. snapshot queue was cleared), both head and tail preserve their values.

The Grant Processor releases structures within the queue snapshot boundary. FIG. 10a depicts the situation where the queue is cleared. In this case the dequeue process tries to write NULL to both the head and tail of queue #100 because it cleared the queue according to its snapshot. The concatenation process does not implement the dequeue process request since the queue was touched. This prevents the dequeue process from clearing the queue at the same time as the enqueue process adds new structures thereto.

FIG. 10b depicts the situation where the queue did not clear. In this case the dequeue process wishes to update the queue head to be structure #3 and this time it succeeds. FIG. 9c indicates that structures #0, #57 and #3 want to depart. However, it is seen in FIG. 10b that the new head and the new tail are both #3. This indicates that only structures #0 and #57 actually succeeded in departing and structure #3 is left on its own. When the newly arriving structures #21 and #208 are now added, they must therefore be concatenated to the remaining tail of structure #3.

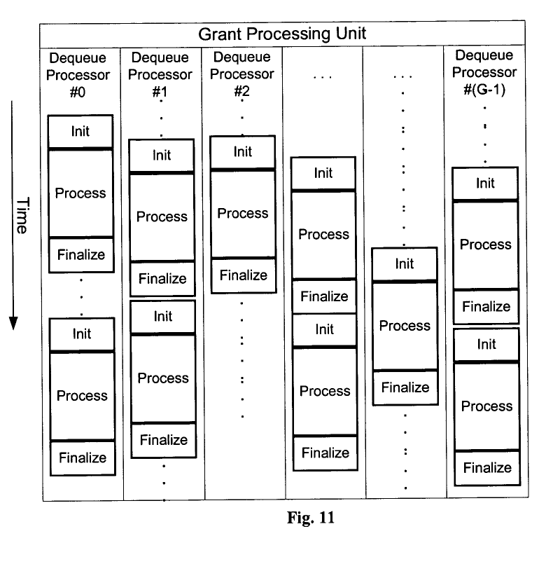

FIG. 11 shows schematically operation of a multiple-context BMU. In the multiple-context case, the BMU may process G grants concurrently (G>1). The BMU holds G distinct snapshot databases, indexed from 0 to G−1. Each grant is marked with a grant index ‘g’ (where 0≦g≦G−1). The scheduling algorithm must never send two concurrent grants to same queue. When a grant indexed ‘g’ enters the BMU, the BMU uses the snapshot database number ‘g’.

In the method claims that follow, alphabetic characters and Roman numerals used to designate claim steps are provided for convenience only and do not imply any particular order of performing the steps.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A data structure depicting one or more queues storing data to be routed by a unicast scheduler, said data structure comprising:
a Structure Pointer memory comprising multiple addressable records, each record storing a pointer to a location in memory of a segment which is a part of a packet associated with a respective queue, a Structure Pointer pointing to a record in the Structure Pointer memory associated with a successive segment of the packet in the queue, a packet indicator indicating whether the segment is a first segment and/or a last segment in the packet,
a Head & Tail memory comprising multiple addressable records, each record storing for a respective queue a corresponding address in the Structure Pointer memory of the first and last packets in the queue, and
a free structure memory comprising multiple addressable records, each record pointing to a next available memory location in the Structure Pointer memory.

2. The data structure according to claim 1, adapted to depict one or more queues storing data to be routed by a multicast schedulerand further comprising:
a multiplicity memory comprising multiple addressable records, each record storing a value corresponding to a number of destinations to which a respective queue is to be routed.

3. An enqueue processor adapted to append a new data packet to a queue having the data structure according to claim 1.

4. An enqueue processor adapted to append a new data packet to a queue having the data structure according to claim 2.

5. A grant processing unit adapted to receive requests for data departing from a granted queue having the data structure according to claim 1, said grant processing unit comprising one or more dequeue processors, each adapted to handle a single grant at a time for removing data from said granted queue.

6. The grant processing unit according to claim 5, wherein each dequeue processor maintains a respective database that includes for each queue a registered snapshot head and tail pointer, an In_process flag that when set indicates that the respective queue is in a dequeue process, and a Touched flag that when set indicates that one or more structures have been added to the respective queue.

7. A grant processing unit adapted to receive requests for data departing from a granted queue having the data structure according to claim 2, said grant processing unit comprising one or more dequeue processors, each adapted to handle a single grant at a time for removing data from said granted queue.

8. The grant processing unit according to claim 7, wherein each dequeue processor maintains a respective database that includes for each queue a registered snapshot head and tail pointer, an In_process flag that when set indicates that the respective queue is in a dequeue process, and a Touched flag that when set indicates that one or more structures have been added to the respective queue.

9. A method for receiving and dispatching data packet segments associated with one or more unicast queues, the method comprising:
(a) storing received packets, segment by segment, each associated with said queues in a data structure that is adapted to manage data packets as linked lists of segments, in the following manner:
i) for each arriving segment, fetching a structure pointer from a free structure reservoir, and fetching a data segment pointer from a free data pointer reservoir;
ii) storing the data segment in a memory address pointed to by said data segment pointer;
iii) storing the data segment pointer in the structure pointed to by the structure pointer;
iv) maintaining a packet indicator in the data structure for indicating if the current segment is a first segment or a last segment or an intermediate segment in the packet;
v) appending the data structure to a structure linked list associated with said queue;
(b) dispatching stored packet train comprising a specified number of segments, segment by segment, from a specified queue using the following steps:
i) creating a snapshot of the linked list associated with said specified queue by copying the list head and tail structure pointers to a snapshot head and snapshot tail pointers;
ii) fetching a data segment pointer from the structure pointed to by the snapshot head pointer,
iii) dispatching a current data segment pointed to by said data segment pointer;
iv) updating the snapshot head pointer to point to a successive structure in the linked list;
v) repeating (ii) to (iv) until the packet indicator of the current segment indicates that the current segment is the end of packet, and dispatching all segments of a successive packet in the queue would result in dispatching more data segments than said specified number of segments;
vi) concurrent with stages ii) to v), allowing reception of segments of newly arrived packets to continue, according to the following measures:
(1) upon arrival of a first segment, initializing the linked list of the specified queue;
(2) storing and managing segments according to stages (a) i) to v);
vii) upon completion of stage (b) v), concatenating segments as follows:
(1) if no new segments have arrived, copying the snapshot head and tail pointers to the queue linked list head and tail pointers;
(2) if the snapshot linked list were completely emptied, preserving the queue linked list, and holding only the newly arriving segments;
(3) otherwise, concatenating the linked list of the newly arrived segments to the snapshot linked list.

10. A method for receiving and dispatching data packets associated with one or more unicast queues, the method comprising:
(a) storing data associated with said queues in a data structure that is configured to include:
i) a Structure Pointer memory comprising multiple addressable records, each record storing a pointer to a location in memory of a segment of a packet associated with a respective queue, a Structure Pointer pointing to a record in the Structure Pointer memory associated with a successive segment in the queue, a packet indicator indicating whether the segment is a first segment and/or a last segment in the packet,
ii) a Head & Tail memory comprising multiple addressable records, each record storing for a respective queue a corresponding address in the Structure Pointer memory of the first and last packets in the queue, and
iii) a free structure memory comprising multiple addressable records, each record pointing to a next available memory location in the Structure Pointer memory;
(b) maintaining for each queue a respective database that includes for each queue a registered snapshot head and tail pointer, an In_Process flag, and a Touched flag;
(c) on one or more segments of incoming data packets arriving at a queue:
i) reading the free structure memory to determine a next available record in the Structure Pointer memory for storing therein data relating to the incoming packet;
ii) storing data pertaining to the incoming packet in the Structure Pointer memory at the next available record, as follows:
if an incoming segment is a first segment in the packet:
1) setting the packet indicator to indicate that the incoming segment is the first and last segment in the packet;
if the incoming segment is not the first segment and not the last segment in the packet:
2) setting the packet indicator to indicate that the incoming segment is an intermediate segment in the packet,
if the incoming segment is the last segment in the packet:
3) setting the packet indicator to indicate that the incoming segment is the last segment in the packet,
4) setting the Structure Pointer to NULL, and
5) if the current record is not the first record, then setting the Structure Pointer of a preceding record to point to the current record;
iii) updating a respective record of the Head & Tail memory corresponding to said queue;
iv) updating the free structure memory to point to an available record; and
v) setting the Touched flag;
(d) upon reception of a grant identifying a granted queue from which a specified number of outgoing data packets should depart:
i) setting the In_process flag when the respective queue is in a dequeue process;
ii) reading a respective record of the Head & Tail memory corresponding to the granted queue and registering corresponding data in the snapshot Head record and the snapshot Tail record;
iii) recovering data at a corresponding record in the Structure Pointer memory pertaining to the snapshot Head record, updating the head using the next structure record of the recovered data, and sending the data pointer of the recovered data to an external module for fetching the data segment pointed to by the data pointer,
iv) updating a respective record of the Head & Tail memory corresponding to said queue; and
v) updating the free structure memory so to add a pointer to the record in the Structure Pointer memory vacated by the outgoing data packet;
vi) repeating stages iii) to vii) until one the following occurs:
1) the snapshot Head becomes equal to the snapshot Tail; or
2) the number of departing packets reaches a prescribed number of packet as given in the grant.

11. The method according to claim 10, wherein the data structure is adapted to depict one or more queues storing data to be routed by a multicast scheduler and further comprises:
a multiplicity memory comprising multiple addressable records, each record storing a value corresponding to a number of destinations to which a respective queue is to be routed;
said method further comprising:
incrementing a respective record of the multiplicity memory corresponding to said queue on one or more incoming data packets arriving at a queue; and
upon reception of a grant if a respective record of the multiplicity memory corresponding to said queue is greater than unity, decrementing said record.

12. The method according to claim 10, including:
i) maintaining an index of the granted queue;
ii) initializing the snapshot head and tail pointers to hold a snapshot of the granted queue;
iii) setting the In_process flag at the beginning of a grant to indicate that the granted queue is now accessed by a dequeue process;
iv) at the beginning of a dequeue process, upon reception of one or more data segments:
1) resetting the Touched flag to indicate that a new structure containing one or more data segments has been added to the queue;
2) writing head of the queue in the head & tail RAM with the pointer associated with the structure that is received first; and
3) diverting the tail of the queue to point to the structure that is received last;
v) during subsequent stages where new structures enter the queue and the Touched flag is set, updating the tail of the queue with the new structures thereby setting the queue's Touched flag; and
vi) upon termination of the grant re-setting the In_process flag.

13. The method according to claim 11, further including concatenating the snapshot linked list with the queue linked list upon termination of a dequeue process.

14. The method according to claim 13, wherein said concatenating comprises:
i) setting two temporary values, temp_Head and temp_Tail, as follows;
1) initializing the temporary values temp_Head and temp_Tail to the values of the granted queue head and tail values taken from the head & tail RAM, respectively;
2) if the queue were cleared, setting both temp_Head and temp_Tail to NULL;
3) if the queue were not cleared, maintaining the value of temp_Tail, and setting temp_Head to point to the last structure, which was not released;
ii) concatenating as follows:
4) if the queue were not touched by the enqueue process, setting both head and tail values of the head & tail RAM to the values of temp_Head and temp_Tail, respectively;
5) if the queue were touched by the enqueue process, and the snapshot queue has not yet been cleared, updating the queue head to the value of temp_Head, and maintaining value of the queue tail;
6) if the queue were touched by the enqueue process, and the snapshot queue was cleared, maintaining the values of both head and tail.

15. A program storage device readable by machine, tangibly embodying a program of instructions executable by the machine to perform method steps for receiving and dispatching data packet segments associated with one or more unicast queues, the method comprising:
(a) storing received packets, segment by segment, each associated with said queues in a data structure that is adapted to manage data packets as linked lists of segments, in the following manner:
i) for each arriving segment, fetching a structure pointer from a free structure reservoir, and fetching a data segment pointer from a free data pointer reservoir;
ii) storing the data segment in a memory address pointed to by said data segment pointer;
iii) storing the data segment pointer in the structure pointed to by the structure pointer;
iv) maintaining a packet indicator in the data structure for indicating if the current segment is a first segment or a last segment or an intermediate segment in the packet;
v) appending the data structure to a structure linked list associated with said queue;
(b) dispatching stored packet train comprising a specified number of segments, segment by segment, from a specified queue using the following steps:
i) creating a snapshot of the linked list associated with said specified queue by copying the list head and tail structure pointers to a snapshot head and snapshot tail pointers;
ii) fetching a data segment pointer from the structure pointed to by the snapshot head pointer,
iii) dispatching a current data segment pointed to by said data segment pointer;
iv) updating the snapshot head pointer to point to a successive structure in the linked list;
v) repeating (ii) to (iv) until the packet indicator of the current segment indicates that the current segment is the end of packet, and dispatching all segments of a successive packet in the queue would result in dispatching more data segments than said specified number of segments;
vi) concurrent with stages ii) to v), allowing reception of segments of newly arrived packets to continue, according to the following measures:
(1) upon arrival of a first segment, initializing the linked list of the specified queue;
(2) storing and managing segments according to stages (a) i) to v);
vii) upon completion of stage (b) v), concatenating segments as follows:
(1) if no new segments have arrived, copying the snapshot head and tail pointers to the queue linked list head and tail pointers;
(2) if the snapshot linked list were completely emptied, preserving the queue linked list, and holding only the newly arriving segments;
(3) otherwise, concatenating the linked list of the newly arrived segments to the snapshot linked list.

16. A computer program product comprising a computer useable medium having computer readable program code embodied therein for receiving and dispatching data packet segments associated with one or more unicast queues, the computer program product comprising:
computer readable program code for causing the computer to fetch for each arriving segment a structure pointer from a free structure reservoir, and to fetch a data segment pointer from a free data pointer reservoir;
computer readable program code for causing the computer to store the data segment in a memory address pointed to by said data segment pointer;
computer readable program code for causing the computer to store the data segment pointer in the structure pointed to by the structure pointer;
computer readable program code for causing the computer to maintain a packet indicator in the data structure for indicating if the current segment is a first segment or a last segment or an intermediate segment in the packet;
computer readable program code for causing the computer to append the data structure to a structure linked list associated with said queue;
computer readable program code for causing the computer to dispatch stored packet train comprising a specified number of segments, segment by segment, from a specified queue until the packet indicator of the current segment indicates that the current segment is the end of packet, and dispatching all segments of a successive packet in the queue would result in dispatching more data segments than said specified number of segments said code including:
computer readable program code for causing the computer to create a snapshot of the linked list associated with said specified queue by copying the list head and tail structure pointers to a snapshot head and snapshot tail pointers;
computer readable program code for causing the computer to fetch a data segment pointer from the structure pointed to by the snapshot head pointer,
computer readable program code for causing the computer to dispatch a current data segment pointed to by said data segment pointer;
computer readable program code for causing the computer to update the snapshot head pointer to point to a successive structure in the linked list;
computer readable program code for causing the computer to allow concurrent reception of segments of newly arrived packets to continue, and including:
computer readable program code for causing the computer upon arrival of a first segment to initialize the linked list of the specified queue;
computer readable program code for causing the computer to store and manage segments;
computer readable program code for causing the computer to concatenate segments and including:
computer readable program code for causing the computer to copy the snapshot head and tail pointers to the queue linked list head and tail pointers if no new segments have arrived;
computer readable program code for causing the computer to preserve the queue linked list, and hold only the newly arriving segments if the snapshot linked list were completely emptied;
computer readable program code for causing the computer to concatenate the linked list of the newly arrived segments to the snapshot linked list if the snapshot linked list were not completely emptied.
